(19) United States
(12) Patent Application Publication
(10) Pub. No.: US 2003/0177492 A1
(43) Pub. Date: Sep. 18, 2003

(54) Semiconductor integrated circuit and program record/playback device, system, and method

(76) Inventor: Takashi Kanou, Kanagawa-ken (JP)

Correspondence Address: Finnegan, Henderson, Farabow,, Garrett & Dunner, L.L.P., 1300 I Street, N.W., Washington, DC, 20005-3315, US

(21) Appl. No.: 10/329,528

(22) Filed: Dec. 27, 2002

(30) Foreign Application Priority Data
Dec. 27, 2001 (JP) 2001-398181

(51) Int. Cl. G06F 3/00; H04N 5/445; G06F 13/00; H04N 7/173; H04N 7/16

(52) U.S. Cl. 725/39; 725/50; 725/51; 725/89; 725/134; 725/142

(57) ABSTRACT

A semiconductor circuit includes a recording device having first data stream and second data stream, the second data stream may be program data that contains multiple sections, and the first data stream may be program information data, may read out whereby the program information data related to the sections may be correlated to the time elapsed from program commencement. A graphic generating device may read out the first data stream and create a first image based on the first data stream. A control device may detect some of the second data stream and read out based on information contained in the first data stream. A decoding device may decode some of said second data stream read out by the control device and a second image may be played back, the second image may be included in the program data.

### CROSS REFERENCE RELATED APPLICATIONS

This application claims the benefit of priority from prior Japanese Patent Application P2001-398181 filed on Dec. 27, 2001, the contents of which are herein incorporated by reference.

### FIELD OF THE INVENTION

The present invention relates to a semiconductor integrated circuit, a program record/playback device, a program record/playback system, and a program record/playback method.

### BACKGROUND OF THE INVENTION

Services offering Electronic Program Guide (EPG) information over broadcast waves and such are now used. By means of the EPG information, viewers can access information about broadcast programs, such as the times various programs begin and end. Recently, the practical use of set-top boxes housing hard discs capable of recording broadcast programs onto the hard discs has started.

With a program record/playback system that records and plays back broadcast programs as well as EPG information by using this sort of set-top box, programs recorded in a hard disc can easily be searched using the EPG information.

In conventional program record/playback systems though, the only EPG information used is program unit information. This information is meant to control the volume of the EPG information transmitted. Therefore, when a decision is made to search data in a recording medium using EPG information, it is possible to search by program units but it is extremely difficult to search for a segment within a program.

Furthermore, with the development of portable terminals in recent years, one would think the opportunities to play back and listen to recorded programs on portable terminals would have risen. However, the use of portable terminals have not increased because display screens of portable terminals are ordinarily extremely small relative to television and computer display screens. Hence, when a recorded program is simply displayed on a portable terminal, a problem occurs in that it is difficult to understand the content, particularly in images with a lot of information.

### SUMMARY OF THE INVENTION

In accordance with an exemplary embodiment of this invention, a semiconductor circuit is provided comprising a recording device having a first data stream and a second data stream, the second data stream includes program data having multiple sections, and the first data stream includes program information data related to the sections and correlated to the time elapsed from program commencement; a graphic generating device to create a first image based on the first data stream; a control device to detect and read out at least a portion of the second data stream based on information included in the first data stream; and a decoding device to decode at least a portion of the second data stream read out by the control device and play back a second image on the graphic generating device, the second image being included in the program data.

Other features, and advantages of the present invention will become apparent from the following detailed description. It should be understood, however, that the detailed description and specific examples, while indicating preferred embodiments of the invention, are given by way of illustration only, since various changes and modifications within the spirit and scope of the invention will become apparent to those skilled in the art from this detailed description. The scope of the invention is defined by the claims.

### BRIEF DESCRIPTION OF THE DRAWINGS

The accompanying drawings, which are incorporated in and constitute a part of this specification, illustrate several embodiments and together with the description, serve to explain the principles of the invention. A more complete appreciation of the present invention and many of its attendant advantages will be readily obtained by reference to the following detailed description considered in connection with the accompanying drawings, in which:

FIG. 1 illustrates an exemplary block diagram of a program record/playback system in accordance with an embodiment of the present invention;

FIG. 2 illustrates a flowchart of a program record/playback method in accordance with an embodiment of the present invention;

FIG. 3 illustrates an example of a table of content in accordance with the present invention;

FIG. 4 illustrates an example of an internal program EPG screen in accordance with an embodiment of the present invention;

FIG. 5 illustrates a conceptual diagram of an exemplary memory area within the hard disc drive in accordance with an embodiment of the present invention;

FIG. 6 illustrates an exemplary block diagram of a program record/playback system in accordance with an embodiment of the present invention;

FIG. 7 illustrates an example of a table of content in accordance with an embodiment of the present invention;

FIG. 8 illustrates a flowchart of a program record/playback method in accordance with an embodiment of the present invention;

FIG. 9 illustrates a flowchart showing exemplary operations from the viewer side of a record/playback system in accordance with an embodiment of the present invention;

FIG. 10 illustrates is an exemplary block diagram of a program record/playback system in accordance with an embodiment of the present invention;

FIG. 11 illustrates is an exemplary block diagram of a program record/playback system in accordance with an embodiment of the present invention;

FIG. 12 illustrates is an exemplary diagram of information in an exemplary table of content in accordance with an embodiment of the present invention;

FIG. 13 illustrates is an exemplary display screen in accordance with an embodiment of the present invention;

FIG. 14 illustrates a flowchart of an enlargement process in accordance with an embodiment of the present invention;

FIG. 15 illustrates an exemplary block diagram of a program record/playback system in accordance with an embodiment of the present invention;

FIG. 16 illustrates an example of a table of content in accordance with an embodiment of the present invention; and

FIG. 17 illustrates a flow chart of a method for creation of caption images in accordance with an embodiment of the present invention.

### DETAILED DESCRIPTION OF THE EMBODIMENTS

Embodiments of the invention will be explained while referring to the accompanying drawings. In these explanations, wherever possible, the same reference numbers will be used throughout the drawings.

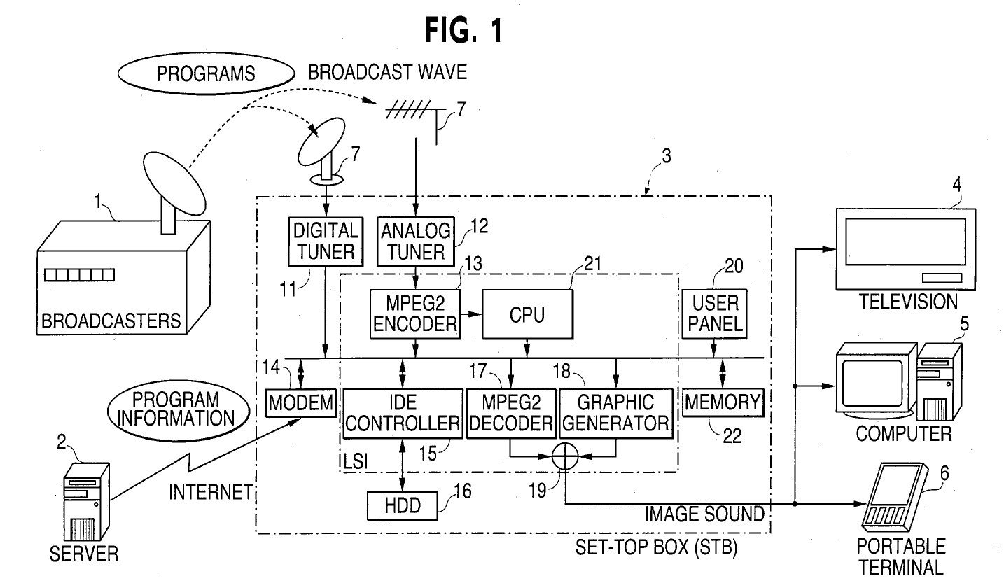

The semiconductor integrated circuit, program record/playback device, program record/playback system, and program record/playback method of the first embodiment of the present invention will be explained using FIG. 1. FIG. 1 is a block diagram depicting an exemplary program record/playback system in accordance with the present embodiment.

The program record/playback system may include a set-top box (3) that receives detailed tables of contents (internal program information) for display of broadcast programs. The detailed tables are furnished by broadcasters (1) over broadcast waves and by websites (2) over the Internet and other such telecommunications. Set-top box (3) in turn provides the program information received over a television receiver (4), a computer (5), or a portable terminal (6) such as a mobile telephone, etc., which displays the programs. Moreover, set-top box (3) may be housed inside the television receiver (4) and within the computer (5). It may also be a broadcast program recording device remotely located from the display device (e.g., computer (5), television receiver (4)). The detailed tables of contents will be discussed later.

The set-top box (3) may include a digital tuner (11) (receiver), an analog tuner (12) (receiving means), an MPEG2 (Moving Picture Experts Group) encoder (13) (receiving means), a modem (14) (receiving means), an IDE controller (15), a hard disc drive (16) (recording means), an MPEG2 decoder (17) (decoding means), a graphics generator (18) (graphic creation means), an adder (19), a user panel (20), a CPU (21) (control means), and a memory (22). Furthermore, for example, the MPEG2 encoder (13), the IDE controller (15), the MPEG2 decoder (17), the graphics generator (18), the adder (19), and the host CPU (21) may be implemented as a one-chip Large Scale Integration (LSI).

The digital tuner (11) receives broadcast programs furnished overdigital waves from broadcasters (1) through an antenna (7). Then, from the received digital broadcast program, a MPEG2 transport system (a data stream, hereafter referred to as MPEG2TS) is obtained. Further, the information furnished by digital broadcast is hypothetically coded in an MPEG2 format.

As another means of receiving broadcast programs, analog tuner (12) receives broadcast programs from broadcasters (1) using analog broadcasting. Then, image and sound signals of the received broadcast program are obtained. The MPEG2 encoder (13) encodes the image and sound signals obtained by the analog tuner (12) in MPEG2 format, and then the analog broadcast program MPEG2TS is obtained. The modem (14) connects the Internet to the set-top box. Then, a detailed table of contents is obtained from a web site via the Internet. The hard disc drive (HDD) (16) records the broadcast program MPEG2TS and the detailed table of contents (first and second data streams, respectively) by means of the IDE controller (15).

The MPEG2 decoder (17) decodes the broadcast program MPEG2TS and the image and sound signals of the broadcast program are obtained. The graphics generator (18) generates the image and sound signals of the EPG screen (program guide screen) based on the detailed table of contents. Then, these image and sound signals are forwarded to the display component (display means), which may be comprised of a television receiver (4), a computer (5) or a portable terminal (6). Then the EPG screen and broadcast program are displayed. The user panel (20) is provided with keys to record, playback, stop, as well as a number pad and such. The user panel (20) is, for example, a television receiver (4) remote control. By a viewer manipulating the user panel (20), the host CPU (21) controls the function of the aforementioned various parts. The data required to operate the CPU (21) may be supplied in individual parts to the memory (22) from user panel (20).

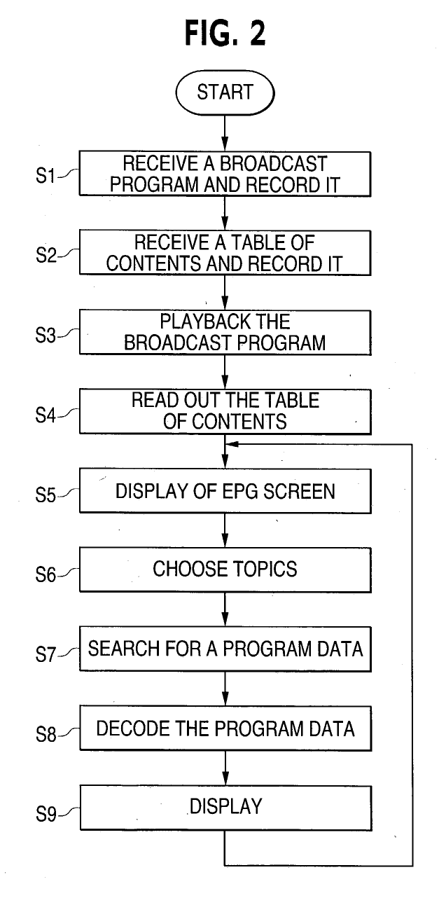

Next, FIG. 1 and FIG. 2 will be used to explain the methods to record/playback the aforementioned broadcast program. FIG. 2 is a flowchart of the program record/playback method.

First, a broadcast program furnished over broadcast waves from a broadcaster (1) is received by antennas (7) and tuners (11), (12). As discussed earlier, a broadcast program is received by a digital tuner (11) when the broadcast is digital, and the MPEG2TS of the broadcast program is received. With analog transmission, a broadcast program is received by an analog tuner (12) and, after the broadcast program's image and sound signals have been obtained, these image and sound signals are encoded by the MPEG2 encoder (13) to obtained MPEG2TS. Then, the broadcast program MPEG2TS is recorded in a hard disc drive (16) (Step S1).

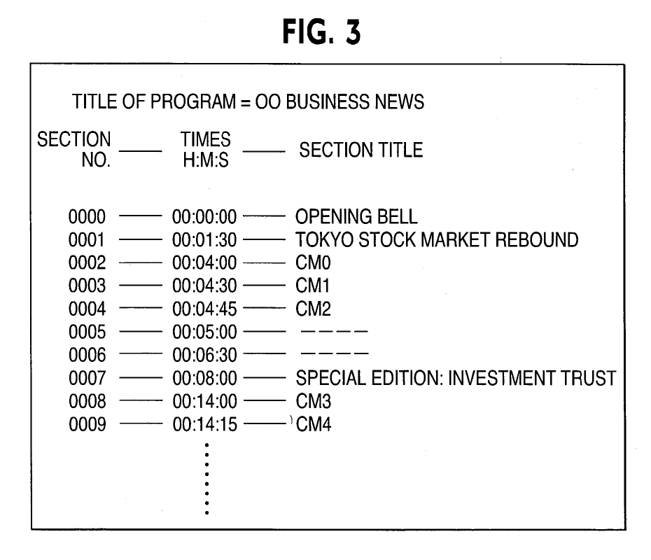

Also, parallel to the recording of the aforementioned broadcast program or after recording of the aforementioned broadcast program is over, a detailed table of contents is downloaded from a web site (2) by way of the Internet. Then, the downloaded detailed table of contents is recorded in a hard disc drive (16) (Step S2). Here, FIG. 3 is used to explain the detailed table of contents. FIG. 3 is a conceptual diagram depicting information contained in the detailed table of contents.

The detailed table of contents relates to a broadcast program in a way analogous to conventional EPG information. However, unlike conventional EPG information, the “program” is such that broadcast programs are introduced not only in program units, but in units broken down more finely than broadcast units. In other words, the detailed table of contents contains section reference numbers, section titles, and the time elapsed from program commencement for each of the sections that should be played back consecutively within a single program.

FIG. 3 is sample detailed table of contents for a news program known as “OO Business News.” In the detailed table of contents for “OO Business News” are contained that days topics, examples being “Tokyo Stock Market Rebounds, “Bank of Japan Short-Term Forecast,” “OO Company, Corporate Reclamation,” “Special Edition—Investment Trusts,” and so on. There are also several commercials (CM0, CM1, CM2 . . . ) contained in the program. These topics and individual commercials are handled within the detailed table of contents as “sections” to be played in continuum. As shown in the diagram, the section reference number (Section No.) and section title assigned to each section are offered by the detailed table of contents along with times elapsed from program commencement. The detailed table of contents may be provided by way of a web site managed by the broadcaster. With live programs, a program's flow is not necessarily limited by the schedule. For example, interruptions can be made for emergency news, etc. Hence, in the case of live programs, it is desirable that a detailed table of contents formed on the basis of the program actually televised be acquired after the broadcast program is recorded. Of course, for programs that are not rebroadcasts or live broadcasts, the flow status of the program content is clear from the outset, and so to acquire a detailed table of contents in parallel with program recording poses no problems.

Returning to FIG. 2, after the aforementioned steps (S1), (S2), the broadcast program and the detailed table of contents are recorded. Thereafter, the viewer manipulates the user panel (20) and starts to replay the aforementioned “OO Business News” broadcast program (Step 3). When doing so, the host CPU (21) reads out the detailed table of contents to the memory (22) in response to the operation of user panel (20) (Step 4). Then, the host CPU (21) commands the graphics generator (18) to create an EPG screen.

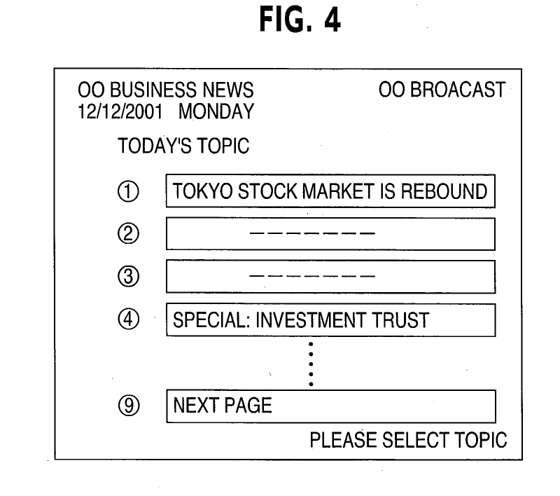

The graphics screen generator (18) creates an EPG screen (hereafter this will be called an “internal program EPG screen”) that shows a detailed table of contents from within the “OO Business News” broadcast program based on the detailed table of contents shown in FIG. 3. The internal program EPG screen is such that the section titles in the detailed table of contents can be easily created such that they are aligned in chronological order by start times. Also, the created EPG screen within a program is displayed on a display component, namely, a television receiver (4), a computer screen (5), or a portable terminal (6). Thus, an internal program EPG screen as shown in FIG. 4 is displayed on the display unit (Step S5), inciting the viewer to select the section he wants to watch.

By looking at the sort of internal program EPG screens depicted in FIG. 4, a viewer can determine the topics contained in that day's “OO Business News.” Based on that, a viewer can choose topics by manipulating the user panel (20) (Step S6). For example, when someone wishes to watch “Tokyo Stock Market Rebound,” he selects [1] from the number pad on the user panel.

In doing so, the host CPU (21) can then search for the area wherein the section called “Tokyo Stock Market Rebound” is contained based on the detailed table of contents (Step 7). The section “OO Business News” starts 1 minute 30 seconds after the program starts and is over 4 minutes and 0 seconds after the program starts (refer to FIG. 3). Hence, the CPU (21) reads out data (MPEG2TS) corresponding to said time region from the hard disc drive (16). Then, the host CPU (21) commands the MPEG2 decoder (17) to decode the MPEG2TS read out from the hard disc drive (16).

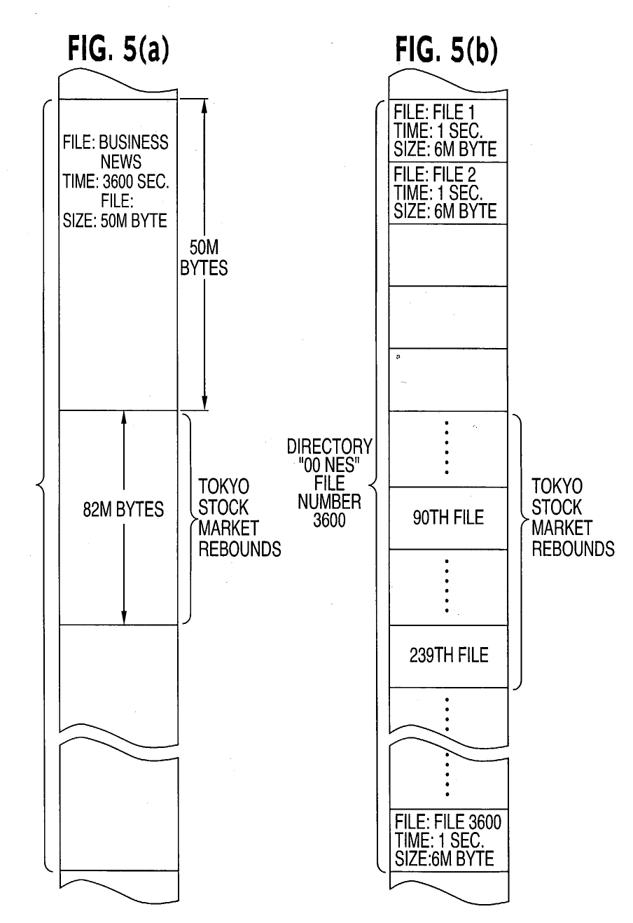

Next, the method to search for playback start points will be explained using FIGS. 5(a) and (b). FIGS. 5(a), (b) is a conceptual diagram of the memory area of the hard disc drive (16). When information in the hard disc drive (16) is managed as file units, the simplest recording method is the method of recording one broadcast program into one file. FIG. 5(a) shows this arrangement. Here, the aforementioned “OO Business News” is recorded, the recording time is 1 hour, and the data volume is 2G bytes. In this case, since time information is not contained in the file, the memory area containing the prescribed section is conjectured from the file size and the recording time, and the CPU (21) accesses the hard disc drive (16). More specifically, first the lead address of the file “OO Business News” in the hard disc is confirmed. Since its capacity for a 1-hour program is 2G bytes, the volume of data used per minute is approximately 22M bytes. The section “Tokyo Stock Market Rebound” lasts 2 minutes 30 seconds after 1 minute 30 seconds from the time the program starts. The data volume for 1 minute 30 seconds is about 50M bytes, and the data volume for 4 minutes is about 132M bytes. Thereby, the 82M bytes of data recorded between the address that is 50M bytes from the lead address of said file to 132M bytes from said lead address corresponds to “Tokyo Stock Market Rebound”.

As for other methods, a broadcast program can also be recorded in a hard disc drive (16) as multiple files apportioned per a prescribed time. A depiction of the memory gap when a program is broadcast by this sort of method is found in FIG. 5(b). In the example in FIG. 5(b), a 1-hour program “OO Business News” is recorded as 3,600 individual files, each with a recording time of one second. These 3,600 files are stored in a disc named, for example, “OO Business News”. In this case, the file itself can be said to be time information. For example, the section called “Tokyo Stock Market Rebound” starts 90 seconds after the program begins, and the next commercial [CMO] starts 240 seconds after the program begins. Hence, when “Tokyo Stock Market Rebound” is read out, the 150 individual files between the 90th and the 239th in from the lead may simply be read out.

The MPEG2 decoder (17) decodes the MPEG2TS of the broadcast program read out by the methods described above (Step S8), and the image and sound signals of the section “Tokyo Stock Market Rebound” are obtained. These are then sent to the display component of a television receiver (4), a computer (5), or a portable communication device (6). Then, the topic “Tokyo Stock Market Rebound” is displayed in the display component, and the recorded program is played back (Step S9).

When “Tokyo Stock Market Rebound” selected by the viewer is finished playing, there is a return again to the internal program EPG screen (Step S5).

As stated above, with the program record/playback system of the present embodiment, first the Internet is used to obtain a detailed table of contents. Contained in this detailed table of contents are the relations between regions to be played back in continuum in the program and time spans in the program. An EPG screen is then created using this detailed table of contents. Furthermore, the CPU provides relations between the time spans contained in the detailed table of contents and the program data (broadcast program MPEG2TS) recorded in the hard disc drive, and program data is searched within the hard disc drive. Hence, when a viewer plays back a recorded program, the recorded program can be selected not in program units but in even more finely apportioned units. As a result, it is easy to search for programs when playing back recorded programs. Moreover, the section the viewer wants can be selected accurately. Also, by acquiring the detailed table of contents by way of the Internet, implementation is possible without consuming transmission bands.

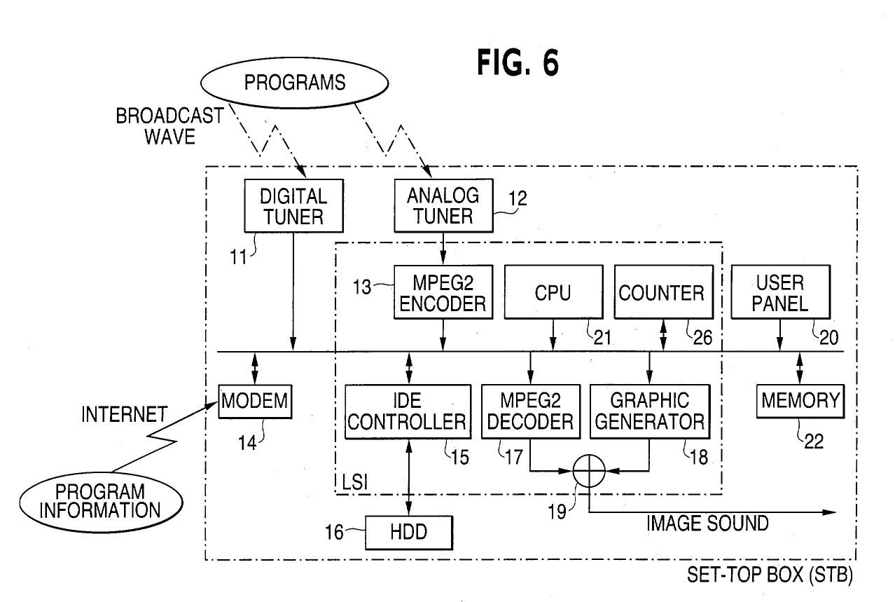

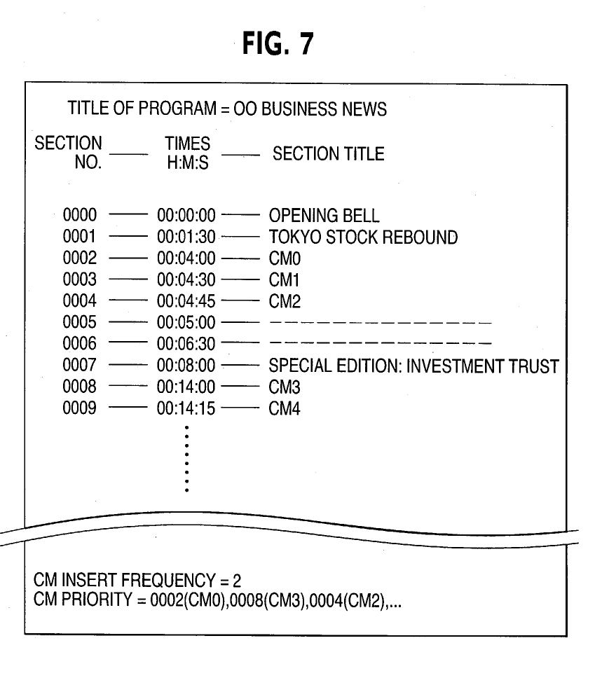

Next, FIG. 6 and FIG. 7 will be used to explain a semiconductor integrated circuit, a program record/playback device, a program record/playback system, and a program record/playback method relating to the second embodiment of this invention.

As shown in FIG. 6, the structure of the program record/playback system is, apart from the addition of a counter (26) inside the set-top box (3), identical to the aforementioned first embodiment, and so an explanation has been eliminated. Moreover, for example, the MPEG2 encoder (13), the IDE controller (15), the MPEG2 decoder (17), the graphics generator (18), the adder (19), the host CPU (21), and the counter (26) may be implemented as a one-chip LSI. Also, the detailed table of contents used in the program record/playback system of the present embodiment is, as shown in FIG. 7, the table explained in the aforementioned first embodiment but also containing a commercial insertion frequency and an insertion priority order. [CM insertion frequency=2] in FIG. 7 means that a commercial (CM) is played back each time two sections (topics) are played back. [CM priority order=0002 (CM0), 0008 (CM3), 0004 (CM2) . . . ] means that commercials are played back in the order CM0→CM3→CM2. Furthermore, the numbers 0002, 0008, 0004 are the section numbers for the corresponding CM.

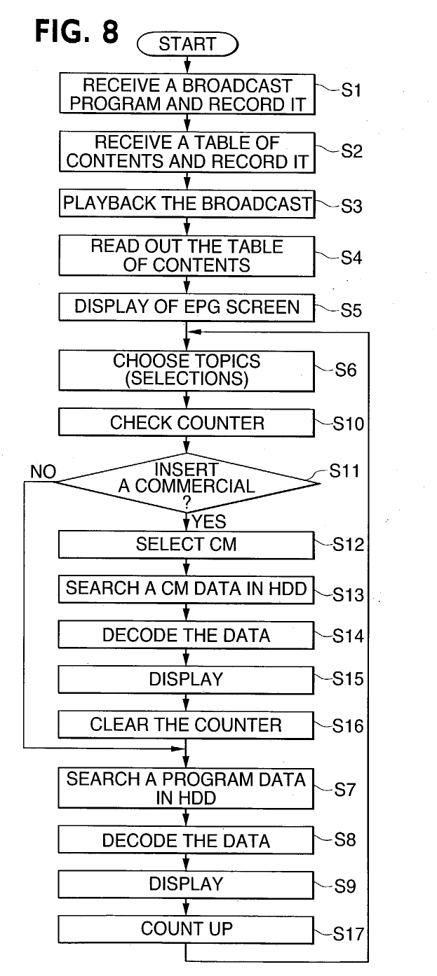

Next, FIGS. 6 through 8 will be used to explain the aforementioned broadcast program record/playback method relating to the second embodiment. FIG. 8 is a flowchart of the program record/playback method.

First, in the method of FIG. 8, the processing up to Step 5 occurs in the same way as in the aforementioned first embodiment, the sort of internal program EPG screen shown in FIG. 4 is displayed, and a viewer is prompted to choose a section. When a section is selected (Step 6), the host CPU (21) checks the counter value in the counter (26). After the CM nearest the section played back is over, the counter (26) shows how many sections have been displayed. Then, the counter value and the commercial insertion frequency contained within the detailed table of contents are compared, whereby a determination is made as to whether or not to insert a commercial (Step S11).

If a decision not to insert a commercial is made, the method proceeds to Steps S7-S9 explained in the aforementioned first embodiment, wherein the program data is searched, decoded, and displayed. Next, the host CPU (21) “counts up” the counter of the CPU (21) (Step S17), followed by a return to the internal program EPG screen for viewer selection of a section (Step S6).

If a decision to insert a commercial is made, the host CPU (21) selects a commercial to insert from among several commercials (Step S12). Here, commercial [CM0] has been selected, for example. Then, within the area in which the “OO Business News” broadcast program is recorded in the hard disc drive (16) of the host CPU (21), the area in which the commercial [CM0] selected at Step S12 is recorded is searched based on the detailed table of contents information and then read out (Step 13). This search method is identical to the section search method in the aforementioned first embodiment. Then, the host CPU (21) commands the MPEG2 decoder (17) to decode the MPEG2TS read out from the hard disc drive (16).

The MPEG2 decoder (17) decodes the MPEG2TS of the read out commercial in line with the command of the host CPU (21) (Step S14), and the commercial image and sound signals are obtained. These are then sent to the display component of a television receiver, a computer, or a portable communication device. Then, the commercial is played back on the display component (Step S15).

After the commercial has been played back, the host CPU (21) sets the count figure of the counter (26) (Step S16). Then, the processing involved in Steps S7-S9 explained in the aforementioned first embodiment advances, whereupon the section the viewer has selected is played back. Once a section the viewer has selected has been played back, the host CPU (21) “counts up” the counter of the CPU (21) (Step S17), followed by a return to the internal program EPG screen for viewer selection of a section (Step S6).

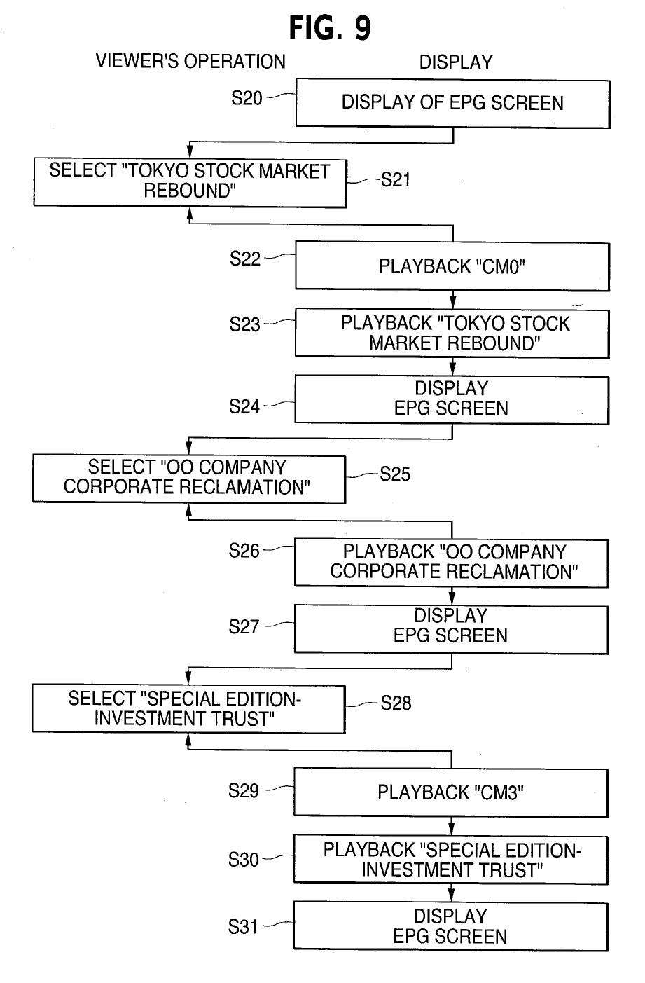

The aforementioned program record/playback method is explained in detail below along with operations on the viewer side and the operations of the display component. FIG. 9 is a flowchart showing operations from the viewer side and operations from the set-top box side when record/playback occurs. In the explanation of FIG. 9, the steps of FIG. 8 are referenced. Furthermore, the counting figure on the counter is initially set at “2”.

First, in line with the processing of Steps S1-S5 in FIG. 8, an internal program EPG screen is displayed on the display component (Step 20). Then, the viewer opts to select a section called “Tokyo Stock Market Rebound” (Step S21). When that happens, the host CPU (21) checks the counter figure of counter (26) (Step S10-FIG. 8). The counter figure is “2” and the commercial insertion frequency in the detailed table of contents is also “2”. Thus, the host CPU (21) makes a determination about CM insertion. (Step S11-FIG. 8). Then, based on the commercial insertion order of priority in the detailed table of contents, the host CPU (21) selects the commercial to be played back. As shown in FIG. 7, the first priority commercial is [CM0], and so the host CPU (21) determines to playback commercial [CM0]. By means of Steps S12-S15 (FIG. 8) that occur based on the decision of the host CPU (21), the commercial [CM0] is first to be played back on the display component. After commercial [CM0] has been played back, the host CPU (21) clears the counter (26) and the counter value becomes zero. Thereupon, the host CPU (21) plays back the section “Tokyo Stock Market Rebound,” which the viewer has selected, in line with the method explained in the aforementioned first embodiment (Step S23). After “Tokyo Stock Market Rebound” is finished playing, the host CPU (21) “counts-up” the counter (Step S17-FIG. 8). The counter value then becomes “1”. Thereafter, the internal program EPG screen is again displayed on the display component (Step S24).

The viewer then opts to select the section called “OO Company, Corporate Reclamation” (Step S25). The host CPU (21) checks the count value of the counter (26) (Step S10-FIG. 8). However, because the counter value is “1”, the host CPU (21) plays back the appropriate section without inserting a commercial (Step S26). After said section has been played back, the host CPU (21) “counts-up” the counter (Step S17-FIG. 8). The counter value thus becomes “2”. Thereafter, the internal program EPG screen is again displayed on the display component (Step S27).

The viewer then opts to select the section called “Special Edition—Investment Trusts.” When the host CPU (21) checks the counter value of the counter (26) (Step S10-FIG. 8), the counter value is “2.” In other words, after the commercial ([CM0]) and immediately prior to said section, two sections (“Tokyo Stock Market Rebound” and “OO Company, Corporate Reclamation”) are played back consecutively. Further, the commercial insertion frequency within the exemplary detailed table of contents is “2”. In other words, before the next selected section “Special Edition—Investment Trusts” is played, a commercial may,be inserted. Hence, the host CPU (21) determines the CM insertion (Step 11-FIG. 8). Then the host CPU (21), based on the order of priority for commercial insertion within the exemplary detailed table of contents, selects the commercial to be played back. As shown in FIG. 7, [CM3] is the commercial with the highest priority after [CM0], and the host CPU (21) decides to play back commercial [CM3]. Owing to the processing of Steps S12-S15 (FIG. 8) that are based on the decision of the host CPU (21), a commercial is first played on the display component (Step 29). After commercial [CM3] has been played, the host CPU (21) clears the counter (26) and the counter value becomes 0.

Thereupon, the host CPU (21) plays back the section “Special Edition—Investment Trusts” selected by the viewer in accordance with the method explained in the aforementioned first embodiment (Step S30). After “Special Edition—Investment Trust” has been played back, the host CPU (21) “counts up” the counter (Step S17-FIG. 8). Hence, the counter value becomes “1”. Thereafter, the internal program EPG screen is again displayed on the display component (Step S31).

According to the program record/playback system of the present embodiment, damage to the profits of program sponsors can be prevented. Ordinarily, when a program is viewed after being recorded, the commercials are easy to skip. Particularly in the case of a set-top box that records programs in a hard disc drive, “time-shift viewing”, wherein playback starts at a stage shortly after the broadcast starts and while taping continues. With this method, almost all programs can be seen in real time and without commercials. A viewing format will result that will be common in the future and that is easier to use than VTR, in which only playback is possible after taping is over. In this case, though, program sponsors get absolutely no payback from their advertising efforts, and so program sponsors suffer enormous losses. However, with the system of the present embodiment, when a viewer selects a section, commercials are inserted forcibly at a prescribed frequency. In other words, because viewers are compelled to watch commercials, the profits of program sponsors can be sufficiently protected. Also, the commercial insertion frequency and insertion order of priority can be set arbitrarily. In the present embodiment, for example, the example described involves inserting one type of commercial after two sections have been played back. However, the number of commercials inserted may be two or more.

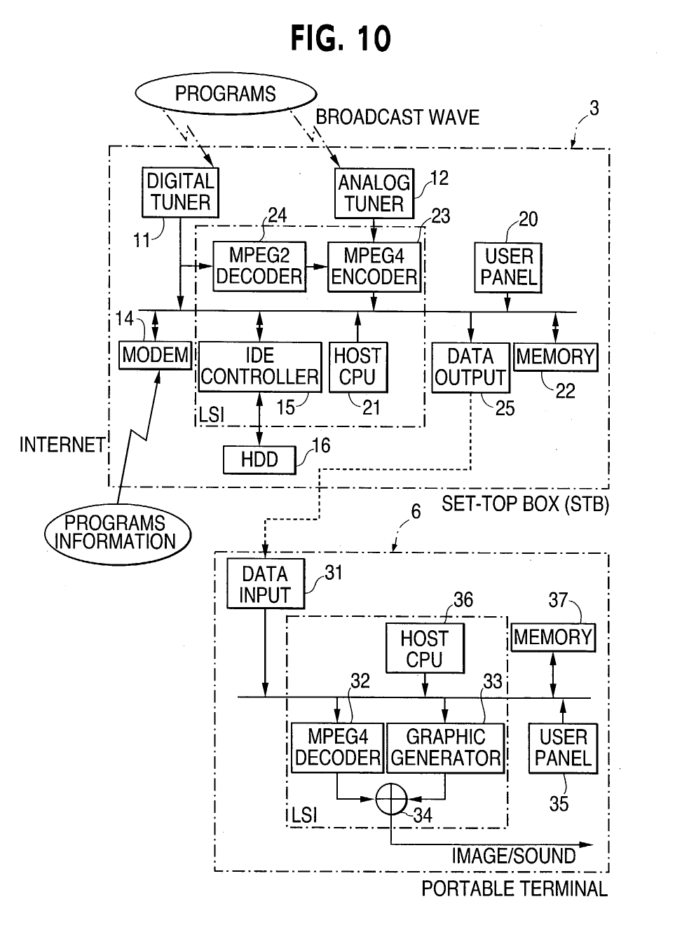

Next, a semiconductor integrated circuit, a program record/playback device, a program record/playback system, and program record/playback method will be explained using FIG. 10. FIG. 10 is a block diagram depicting the structure of a program record/playback system. The present embodiment depicts a case in which programs recorded in the set-top box (3) (recording device) housed inside of, for example, a television receiver are played back on a mobile telephone, a portable television, or another such portable terminal (PDA: Personal Digital Assistant).

The structure of the set-top box (3) is such that in the structure explained in the aforementioned first embodiment, the MPEG2 encoder (13) is replaced by the MPEG4 encoder (23), and the MPEG2 decoder (24) and the data sending component (25) are added. When the MPEG2 decoder (24) decodes digital broadcast programs in MPEG2 format, the MPEG2TS of the broadcast program obtained by the digital tuner (11) is decoded. Then, the sound and image signals of the broadcast program are obtained. The MPEG4 encoder (23) codes the sound and image signals of the broadcast program obtained by the analog tuner (12) and the MPEG2 decoder (24) in MPEG4 format, and then the broadcast program MPEG4TS is obtained. The data sending component (25) sends the MPEG4TS of the detailed table of contents and the broadcast programs recorded in the hard disc drive (16) (first recording means) to a portable terminal. Moreover, for example, the MPEG2 decoder (24), the MPEG4 encoder (23), the IDE controller (15), and the host CPU (21) may be implemented as a one-chip LSI.

The portable terminal (6) has a data input component (31), an MPEG decoder (32), a graphics generator (33) (means to create graphics), an adder (34), a user panel (35), a host CPU (36) (control means), and a memory (37) (second recording means). The data input component (31) receives the MPEG4TS of the broadcast programs sent from the data sending component (25) of the set-top box (3). The MPEG4 decoder (32) decodes the MPEG4TS of the received broadcast program, and image and sound signals of the broadcast program are obtained. The graphics generator (33) creates an internal program EPG screen based on the MPEG4TS of the received detailed table of contents. The adder (34) combines the image and sound signals obtained by the MPEG4 decoder (32) and the graphics generator (33). Then, these image and sound signals are sent to the display component of a portable terminal (6), whereupon the internal program EPG screen is displayed and the broadcast program is played back. In the case of a mobile telephone, for example, the user panel (35) corresponds to the dialing component. When a viewer manipulates the user panel (35), the host CPU (36) controls the operations of the aforementioned various components. Moreover, for example, the MPEG4 decoder (32), the graphics generator (33), the adder (34), and the host CPU (36) may be implemented as a one-chip LSI.

Next is an explanation of the program record/playback method of the aforementioned program record/playback system. The specific operations are the same as the method explained in the aforementioned first embodiment. First, broadcast programs furnished over broadcast waves are received and recorded in the hard disc driver (16) as MPEG4 format data. Also, in parallel with the receipt of the aforementioned broadcast program, or after receipt of the broadcast program, detailed table of contents information relating to the aforementioned broadcast program is downloaded from a web site and recorded on a hard disc drive (16). Thereafter, the broadcast program and the MPEG4TS of the detailed table of contents are sent from the sending component (25) of the set-top box (3) to a portable terminal (6).

The portable terminal (6) receives the MPEG4TS sent from the set-top box (3) at the data input component (31). It does not matter by what method data is sent and received between the set-top box (3) and the portable terminal (6). Although, the types of methods found below can be used.

The data sending component (25) of the set-top box (3) and the data input component (31) of the portable terminal (6) are connected by a cable. Also, a terminal is provided in the sending component (25) and the data input component (31), bringing the terminal into mutual contact, whereby direct data can be transmitted.

Using wireless communications, data is sent from the data sending component (25) of the set-top box (3) to the data input component (31) of the portable terminal (6).

The memory (37) of the portable terminal (6) is in a removable format and, in addition, a memory write-in function is provided in the set-top box (3). Then, using the memory write-in function of the set-top box (3), data recorded in the hard disc drive (16) is written into the memory (37).

With the sort of method discussed above, it is possible to transmit data recorded in the set-top box (3) to a portable terminal. In particular, when data is transmitted by the contact of the terminals aforementioned in (1), it is possible to complete data transmission while the portable terminal (6) is charged, thereby increasing convenience.

Next is an explanation of the program playback method in the portable terminal (6). First, a viewer manipulates the user panel (35) of the portable terminal (6) and then playback of the program transmitted to the memory (37) begins. When program playback occurs, then, as explained in the aforementioned first embodiment, first the graphics generator (23) creates an internal program EPG screen based on a detailed table of contents. Then, within the memory (37), the area in which the section selected by the viewer is recorded is searched, and the MPEG4TS of said location is decoded by the MPEG4 decoder (32). The image and sound signals of the broadcast program obtained by decoding the MPEG4TS are sent to the display component of the portable terminal (6), and then the broadcast program is played back. Furthermore, if the MPEG4TS bit rate recorded in memory (37) is a fixed rate, then the playback start address of the broadcast program is:

Playback start address=program lead address+bit rate×time span.

As discussed above, through the program record/playback system of the present embodiment, a broadcast program recorded in the set-top box (3) can be played back and viewed on a portable terminal. Moreover, in FIG. 10, the MPEG2 decoder (17), the graphics generator (18), and the adder (19) inside the set-top box (3) are missing since this discussion concerns playback on a portable terminal (6). Naturally, though, these components are necessary when playing back on a television receiver.

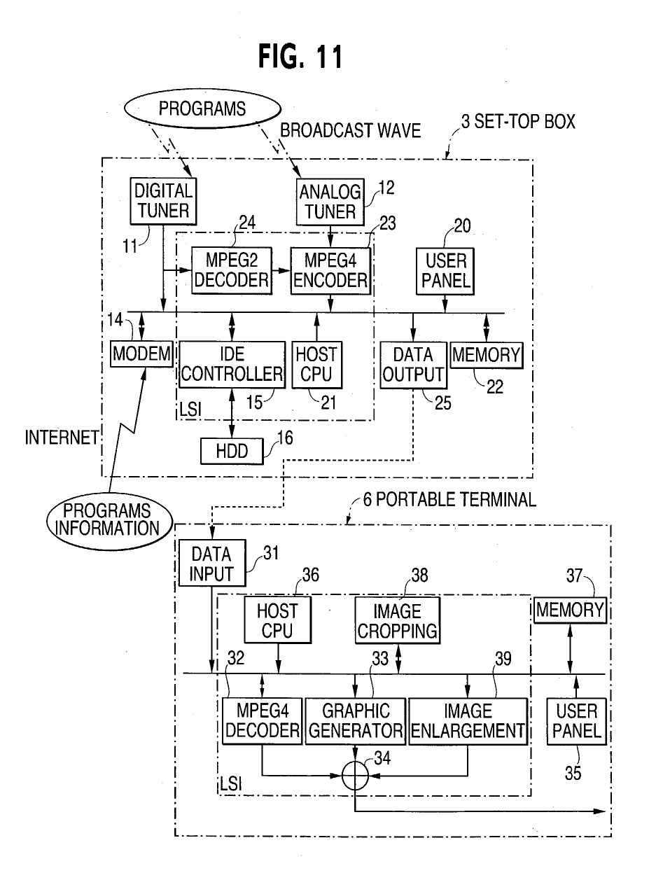

Next, a semiconductor integrated circuit, the program record/playback device, the program record/playback system, and the program record/playback method of the fourth embodiment of the present invention will be explained using FIG. 11. FIG. 11 is a block diagram depicting the structure of a program record/playback system. As with aforementioned embodiment 3, the present embodiment depicts a case in which programs recorded in a set-top box (3) are played back by a portable terminal such as a portable television, a mobile telephone, etc.

The set-top box (3) has the same structure of the aforementioned third embodiment. In addition, moreover, the portable terminal (6) has an image cropping component (38) (image cropping means) and an image enlargement component (39) (image enlargement means). The image cropping component (38) extracts a part of the image obtained by the MPEG4 decoder. The image enlargement component (39) enlarges a part of the image extracted by the image cropping means. Moreover, for example, the MPEG4 decoder (32), the graphics generating device (33), the adder (34), the image enlarger (39), the image cropping component (38), and the host CPU (36) may be implemented as a one-chip LSI.

Next is an explanation about the program record/playback method of the aforementioned program record/playback system. The specific functions are the same as explained in the aforementioned first embodiment. Initially, a broadcast program furnished over broadcast waves is received and then recorded as MPEG4 format data in a hard disc drive (16). Also, in parallel with the receipt of the aforementioned broadcast program, or after receipt of the broadcast program, a detailed table of contents about the aforementioned broadcast program is downloaded from a web site and recorded in the hard disc drive (16). Thereafter, the MPEG4TS of the detailed table of contents and the broadcast program are sent to a portable terminal (6) from the sending component (25) of the top-set box.

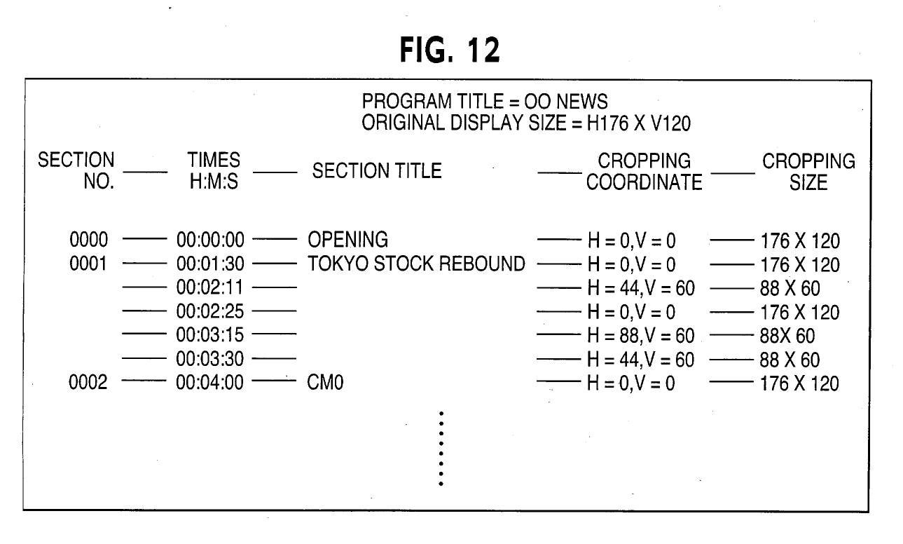

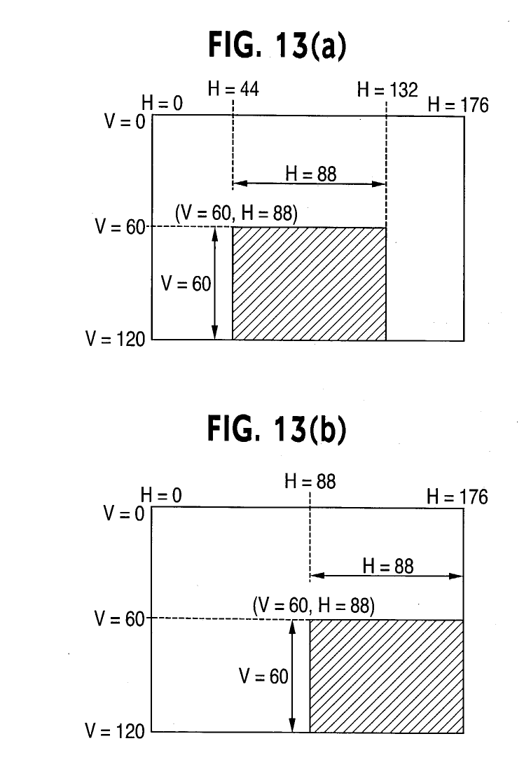

In the detailed table of contents furnished from the web site in the present embodiment is contained information on image enlargement/non-enlargement. FIG. 12 is a conceptual diagram depicting information contained in the detailed table of contents. As shown in the figure, the detailed table of contents contains section numbers, time spans, section titles, as well as information about original display sizes, cropping coordinates, and cropping sizes (playback range information). “Original display size” refers to the number of pixels displayed during standard playback. For example, the number of pixels in standard playback is 176 pixels horizontally (H)×120 pixels vertically (V). The cropping coordinates are the image origins of the screen that will actually be displayed in standard playback relative to the original size. The points at which these cropping coordinates and cropping sizes change are shown, together with the elapsed time from program commencement. The actual meaning of the cropping coordinates and cropping sizes displayed in FIG. 12 will be explained using FIG. 13. FIGS. 13(a) (b) show display screens.

First, with respect to the time span comprising the time range from 00:00:00 to 00:02:11, the cropping coordinates are (H=0, V=0) and the cropping size is H176×V120, and so this is standard playback. In other words, this means the entire decoded image is displayed. As to the time span comprising the time range from 00:02:11 to 00:02:25, the cropping coordinates are (H=44, V=60) and the cropping size is H88×V60. In this case, as shown in FIG. 13(a), within the decoded image the coordinates are located ½ from the origin of the vertical line and ¼ from the origin of the horizontal line, which means that in an image whose range is H88×V60 in FIG. 13(a), the hatched section will be displayed. Further, with respect to the time span comprising the time range from 00:03:15 to 00:03:30, the cropping coordinates are (H=88, V=60) and the cropping size is H88×V60. In this case, then, as shown in FIG. 13(b), the coordinates in the decoded image are ½ from the origin in the vertical direction and ½ from the origin in the horizontal direction. In other words, for an image of a set time, the detailed table of contents contains a command to extract and display only part of a whole image.

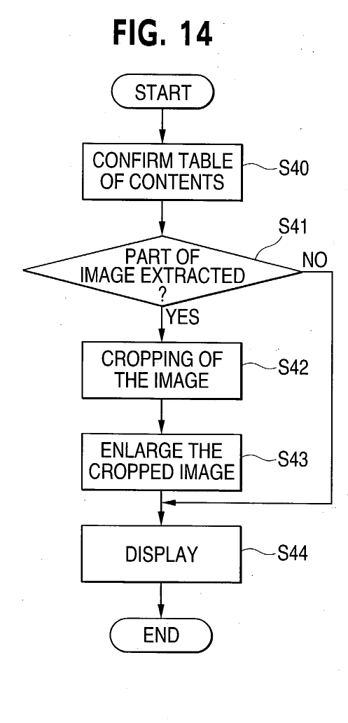

Then, the viewer manipulates the user panel (35) of the portable terminal (6) and the program transmitted to the memory (37) starts to play. As explained in the aforementioned first embodiment, when a program plays back, initially the graphics generating device (23) creates the internal program EPG screen shown in FIG. 4 based on the detailed table of contents. The processing that occurs after the internal program EPG screen is created is explained using the flowchart of FIG. 14.

When a viewer selects a section, the portable terminal (6) of the host CPU (36) searches within the memory (37) for the area wherein said program is recorded and reads out the MPEG4TS of that location. Then, the decoding with the MPEG4 decoder (33) of the MPEG4TS read out begins and the CPU (36) confirms the detailed table of contents (Step S40). Here, the information that the CPU (36) is to confirm, in particular, are the cropping coordinates and the cropping size in the detailed table of contents. For example, in the time band in FIG. 12 discussed above of time 00:02:11 to 00:02:25, the detailed table of contents contains information to the effect that a part of the image is extracted and displayed (Step S41 (Yes)). Then, the CPU (36) commands the image cropping component (38) to crop from the whole image a new image with a range of H=88×V=60 with new coordinates at ½ from the origin in the vertical direction and ¼ from the origin of the horizontal direction (Step S42). Furthermore, the CPU (36) calculates the magnification necessary to convert an image cropped at H=88×V=60 to the standard size H=176×V=120. In this example, the cropped image is ½, both vertically and horizontally, that of the standard size, and so a standard size image is obtained by enlarging the cropped image 2× both horizontally and vertically. The CPU (36) then commands the image enlargement component (39) to enlarge the cropped image 2× both horizontally and vertically (Step S43). An image screened by the image enlarger (39) is then displayed on the display component (Step S44). The same processing occurs in the time bands 00:03:15 to 00:03:30 and 00:03.30 to 00:04:00. In the time band 00:00:00 to 00:02:11, image cropping and enlargement relative to the image to be displayed at standard size (Step S41 (No)) does not occur, and the image obtained by the MPEG4 decoder is displayed on the display component unchanged.

With the program record/playback system of the aforementioned embodiments, it is possible at the time a recorded program is played back to switch automatically between ordinary full-screen playback and enlarged-section playback. This proves to be especially effective when watching a broadcast program on a portable terminal.

Furthermore, the image cropping coordinates and cropping size information in the detailed table of contents are also possible using panscan parameters contained in a MPEG2 data stream. Panscan parameters are parameters that designate the display range of an image in MPEG2. When these parameters are set, the MPEG2 decoder automatically crops the designated display range and the cropped image is enlarged. However, this function is usually added to MPEG2 decoders as an option. If the MPEG2 decoder is not of this type, it cannot be used. Also, when panscan parameters are used, the aforementioned information must be inserted into the transport stream of the broadcast program itself, which is difficult to do during live broadcasts such as the news, and so the present embodiment is effective. Moreover, the present embodiment can also be used with analog broadcast programs.

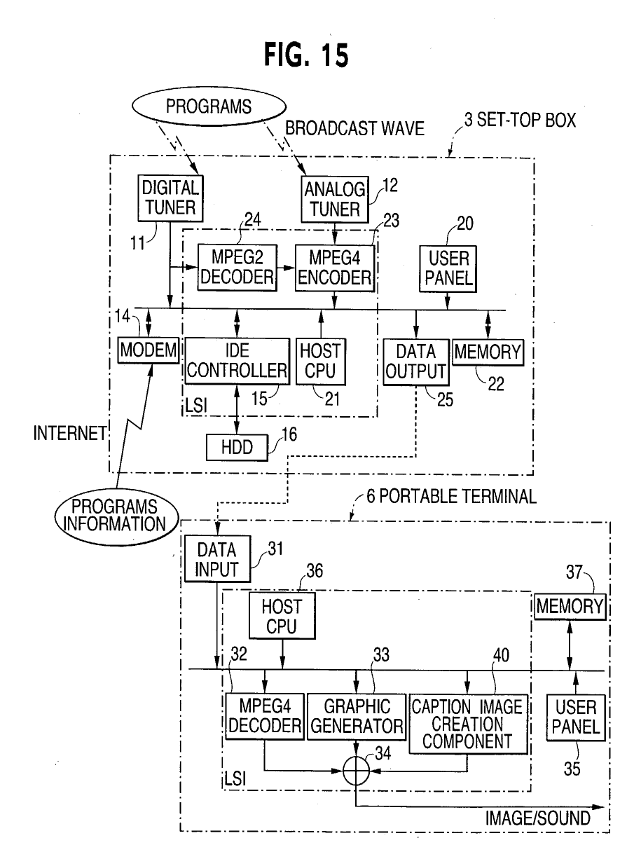

Next, the semiconductor integrated circuit, the program record/playback device, the program record/playback system, the program record/playback method of the fifth embodiment of the present invention will be explained using FIG. 15. FIG. 15 is a block diagram showing the structure of a program record/playback system. The present embodiment, as with the aforementioned third and fourth embodiments, shows a case in which a program recorded in a set-top box is played back on a portable terminal such as a mobile telephone, etc.

The set-top box (3) has the same structure as that of the aforementioned third embodiment. Moreover, the portable terminal (6) in this case involves a caption image creation component (40) (means to create images comprising sequences of characters). Moreover, for example, the MPEG4 decoder (32), the graphics generator (33), the caption image creation component (40), the adder (34), and the host CPU (36) may be implemented as a one-chip LSI.

Next is an explanation about the program record/playback method of the aforementioned record/playback system. The specific operations are the same as those explained for the aforementioned first embodiment. First, a broadcast program furnished over broadcast waves is received and recorded in a hard drive disc (16) as a MPEG4 format data stream. Further, parallel to the receipt of the aforementioned broadcast program, or after receipt of the broadcast program, a detailed table of contents about the aforementioned broadcast program is downloaded from a web site and recorded in the hard disc drive. Thereafter, the broadcast program and the MPEG4TS of the detailed table of contents is transmitted from the sending component (25) of the set-top box (3) to a portable terminal (6).

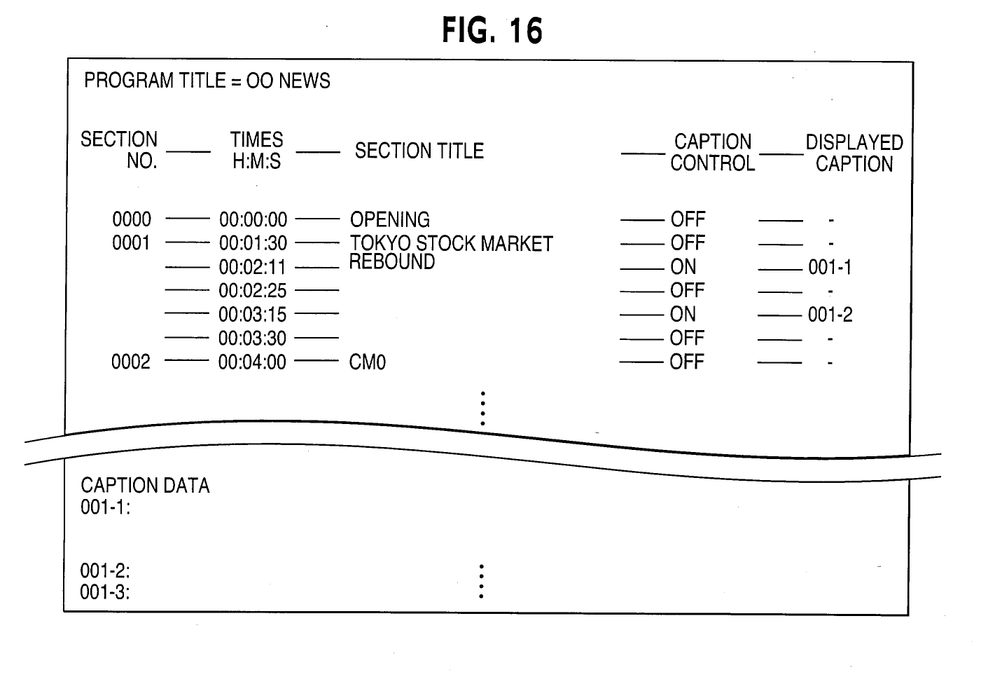

FIG. 16 is a conceptual diagram showing information contained in a detailed table of contents. As shown in the figure, the detailed table of contents contains section numbers, time spans, section titles, as well as caption controls, display captions, caption data (character sequences) and other such information (information related to character sequences). Captions are character information contained within an image. In the present embodiment, when an image includes captions and those captions are difficult to discern, the broadcast program image is not displayed, and display data downloaded from a different web site improves a viewer's ability to discern what is displayed. The “caption controls” in the detailed table of contents is information about whether or not to insert the sort of captions discussed above. Also, “display captions” may be information about which caption data to insert when caption insertion occurs. Further, “caption data” may be data about captions that are actually inserted and is data downloaded from a web site, for example text format data.

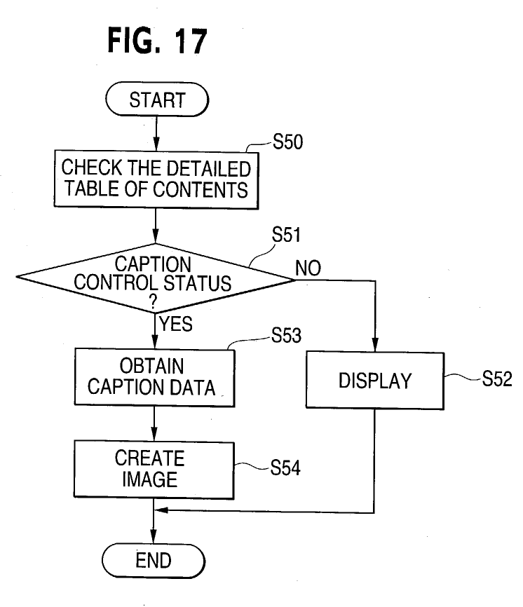

Then, the viewer manipulates the user panel (35) of the portable terminal (6) and the program transmitted to the memory (37) starts to play back. When this program plays back, at first the graphics generator (23) creates the kind of internal program EPG screen shown in FIG. 4 based on the detailed table of contents, as explained in the aforementioned first embodiment. The flowchart of FIG. 17 is used to explain the processing that occurs after the internal program EPG screen is created.

When a viewer selects a section, the host CPU (36) of the portable terminal (6) searches the area wherein said section is recorded within the memory (37) and reads out the MPEG4TS of that location. Then, the MPEG4 decoder (32) starts to decode the read out MPEG4TS and the CPU (36) checks the detailed table of contents (Step S50). Here, the information the CPU (36) checks is the ON/OFF status of the caption control (Step S51 (No)). For example, the caption control is OFF in the time band comprising 000:000:000 to 00:02:11, as shown in FIG. 16. In this case, a broadcast program image obtained by MPEG4 data is displayed as usual (Step S52). On the other hand, the caption control is ON in the time band comprising 00:000:000 to 00:02:11 (Step 51 (yes)). Also, the display caption is 001-1. Hence, the CPU (36) obtains the caption data about the displayed caption 001-1 from the detailed table of contents (Step S53). Then, the caption image creation component (40) creates a caption image (character image) based on the obtained caption data and which is displayed on a screen (Step S54). For example, such an image can be displayed in the screen of a portable terminal. In other words, a caption image created by the caption image creation component (40) is displayed rather than an image decoded by the MPEG4 decoder (32).

With the program record/playback system of the aforementioned embodiment, when a recorded program is played back, a caption image based on character information contained in the detailed table of contents is displayed rather than an image presented by a broadcast program. In other words, as explained in the aforementioned fourth embodiment, the display screen of a portable terminal is extremely small compared to that of a television receiver or such.

Further, when the program itself is compress coded to a small data volume, the ability to discern an image barely improves, even if the image is displayed as an enlargement, as in the aforementioned fourth embodiment. Moreover, it is difficult when the image screen is dotted with multiple pieces of character information rather than information all being concentrated within a partial area of the screen to adapt to a method whereby part of the screen is cropped and enlarged. However, according to the method of the present invention, a caption image created by the caption image creating component (40) based on character data obtained from a web site is displayed. Therefore, since the broadcast program itself is not displayed in the display component of the portable terminal, character information can be displayed clearly even if the program is compressed to a low bit rate. Furthermore, unlike the fourth embodiment, the location of the character information is not an issue at all. In other words, even if character information is located in various places on the screen, all of that character information can be displayed crisply provided that all of that character information can be acquired from the detailed table of contents.

This is also effective in cases where nearly the whole screen is occupied by character information and in which the individual character size on the original screen is small. Since individual characters are small, it is difficult to discern the character information at that size when displayed on a portable terminal. However, because the whole screen in occupied by character information, enlargements cannot be displayed. With the method of the present embodiment, though, character information can be furnished by a web site. In this case, if the web site confirms that said character information could be played back on a portable terminal, the content of the character information can be processed. In other words, if character sequences are long, caption data in which character sequences are partially modified can be furnished. When that occurs, caption images with relatively large sized characters can be created by the caption image creation component on the portable terminal side, thereby improving the ability to discern characters. Furthermore, when there is a great deal of character information, this fact is submitted to the detailed table of contents, whereby the arrangement is such that a single image with a great deal of character information can be displayed as two caption images. Conversely, cases can also be imagined in which no images are displayed behind the character sequence information and, with just character sequence information, the content can be difficult to discern. In such cases, the disadvantage of having no background image can be sufficiently compensated if supplemental character information is furnished to the detailed table of contents as caption data.

As discussed above, Embodiments 1 to 5 of the present invention are such that parallel to the recording of broadcast programs, or after recording, a detailed table of contents is obtained that contains time span information. Hence, by using this time span information, areas contained in sections within programs recorded in a hard disc drive can be searched. Consequently, viewers can search programs with more finely segmented “internal program section units”, and not search broadcast programs by program units. Also, in cases where recorded programs are played back by a portable terminal whose display component is far smaller than a television receiver, part of the principal image is cropped, and that cropped image is enlarged and displayed on a display component. Moreover, when character information that is difficult to discern is included, the content of this character information is acquired separately by way of the Internet, and caption images are displayed on the display component instead of broadcast program images. As a result, the content of a broadcast program in a portable terminal is easy to discern. The aforementioned detailed table of contents is acquired by way of the Internet. Therefore, programs can be broadcast not only in digital format but also in analog format, and without eventually consuming broadcast wave transmission bands.

Furthermore, broadcast programs and detailed tables of contents in the aforementioned first and second embodiments are coded in MPEG2 format. However, they may also be coded in MPEG1, MPEG4, and MPEG7 formats, or in a format other than MPEG. Likewise, coding in the third through fifth embodiments may be in MPEG1, MPEG2, MPEG7, or some other format. Also, instead of a hard disc drive (16), the set-top box may have as a recording medium, for example, an EEPROM (Electrically Erasable and Programmable ROM), a semiconductor memory, an optical disc, etc.

Furthermore, one can imagine that, particularly in using broadband diffusion, programs heretofore furnished over broadcast waves can be distributed to televisions by means of these networks. In this way, this invention can be applied to cases in which programs are furnished by telecommunications rather than by broadcasting. Furthermore, as discussed above, cases in which programs and detailed tables of contents are both furnished by broadcast waves are also suitable.

Also, in combining the aforementioned second, third, and fifth embodiments to playback programs on a broadcast terminal, commercial display control may still occur.

In addition, when combining the fourth and fifth embodiments and displaying an enlargement in a part of the screen, caption display may occur in the other part. It is also possible, moreover, to combine various appropriate embodiments.

Moreover, the present invention is not limited to the aforementioned embodiments but can be variously modified within a framework whereby one does not deviate from the essence of the invention at the stage when the invention is implemented. Moreover, the aforementioned embodiments include inventions at various stages, and a variety of inventions can be deduced by properly combining the multiple structural provisions disclosed. For example, even if some of the structural provisions are eliminated from all of the structural provisions disclosed in the embodiments, structures wherein these structural provisions have been eliminated can be deduced as inventions if the problems found in the “Background of the Invention” section can be resolved and the outcomes discussed in the “Detailed Description of the Embodiments” section are effected.

As explained above, the present invention provides a semiconductor integrated circuit, a program record/playback device, a program record/playback system, and a program record/playback method whereby recorded programs can be searched easily, and program content can be discerned accurately.

What is claimed is:

1. A semiconductor integrated circuit comprising:
a recording device receiving a first data stream and a second data stream, said second data stream includes program data having multiple sections, and said first data stream includes program information data related to said sections and correlated to the time elapsed from program commencement;
a graphic generating device to create a first image based on said first data stream;
a control device to detect and read out at least a portion of the second data stream based on information included in said first data stream; and
a decoding device to decode at least a portion of said second data stream read out by said control device and to play back a second image on said graphic generating device, said second image being included in said program data.

2. The semiconductor integrated circuit according to claim 1, wherein said control device reads out said second data stream for each of said sections.

3. The semiconductor integrated circuit according to claim 1, further comprising:
an image cropping device to crop at least a portion of said second image generated by said decoding device; and
a picture enlargement device to enlarge said second image cropped by said image cropping device.

4. The semiconductor integrated circuit according to claim 3, wherein
said first data stream is program information data that displays information and a screen extraction indicator correlated to the time elapsed from program commencement;
said control device reads out said second data stream for each of said sections; and
said image cropping device can crop said second image in accordance with playback range information.

5. The integrated semiconductor circuit according to claim 1, further comprising a character image creating device to create character images for display on the graphic generating device.

6. The integrated semiconductor circuit according to claim 5, wherein
said first data stream is program information data that displays information regarding said sections and a flag indicator for a character display related to said program in correlation with time elapsed from program commencement;
said control device reads out said second data stream for each of said sections; and
an image cropping device crops said character images in accordance with character text information.

7. A program recording/playback device comprising:
a first receiving device to receive a first data stream, said first data stream including program information data related to sections correlated to time elapsed from program commencement;
a second receiving device to receive a second data stream including program data that includes said sections;
a recording device to record said first data stream and said second data stream;
a graphic generating device to create a guidance image introducing said sections of said program data based on said first data stream read out from said recording device;
a control device, using the correlation between said program information data related to sections and time elapsed from program commencement, to search a data stream corresponding to any of said sections among said second data stream of said program data within said recording device and then read out; and
a decoding device to decode at least a portion of said second data stream read out by said control device and an image corresponding to said second data stream is played back.

8. The program record/playback device according to claim 7, wherein
said program information data further comprises:
playback range information showing a flag indicator for screen-enlargement playback correlated to time elapsed from program commencement;
an image cropping device to crop a portion of said image played back by said decoding device in accordance with said playback range information; and
an image enlargement device to enlarge an image cropped by said image cropping device.

9. The program record/playback device according to claim 7, wherein
said program data further comprises character information that shows character data and a flag indicator for character information correlated to time elapsed from program commencement.

10. The program record/playback device according to claim 7, wherein said program data further includes:
multiple pieces of commercial information that can be inserted between said sections, said program information including a relationship between said time elapsed from program commencement and said commercial information, and playback order of priority and playback frequency of said commercial information, whereby said control device determines whether or not to playback said commercial information based on said playback frequency of said commercial information and, in case said commercial information is played back, a data stream of said section is read out and commercial information to be played back is selected based on playback rank of said commercial information and, using the relationship between said time elapsed from commencement of said program data and said commercial information, said data stream of said section can be searched among said program data of said recoding device and then read out; and
a decoding device to decode wherein said commercial information read out by said control device and said section data stream, and playback said commercial information and an image of said program data.

11. The program record/playback device according to claim 7, further comprising a data sending device to externally transmit said image played back by said decoding device.

12. The program record/playback device according to claim 7, further comprising a modem connectable to a telecommunications circuit, wherein said program information data is provided from said modem.

13. The program record/playback device according to claim 7, wherein said program data is recorded in said recording device as multiple files for each unit of time.

14. A program record/playback method comprising:
recording program data containing sections and program information data showing information about said sections correlated to time elapsed from program commencement, said program data and program information data being obtained by way of broadcast waves or by telecommunications;
reading out a first data stream of said program information data recorded;
displaying a guidance image introducing said sections contained in said program data based on said program information data;
prompting a viewer to select said section which said viewer wants to watch said guidance image;
searching a data stream for said section selected by said viewer using a relationship between said sections contained in said program information data and times elapsed from program commencement;
reading out said data stream;
decoding said data stream of said section; and
playing back an image of said section.

15. A program record/playback method according to claim 14, wherein playing back said image further comprises displaying said program information data with playback range information that displays a flag indicator of screen enlargement correlated to time elapsed from program commencement;
cropping part of said image that was played back based on said playback range information; and
enlarging said image which is cropped.

16. A program record/playback method according to claim 14, wherein playing back said image further comprises displaying said program information data comprising character information that shows character sequence data and a flag indicator of a character sequence about said program data correlated to the time elapsed from commencement of said program data.

17. A program record/playback method according to claim 16, further comprising:
creating a character sequence image containing said character sequence data before reading out said data stream of said section.

18. A program record/playback method according to claim 14, wherein recording program data further comprises recording said program information including commercial information that can be inserted between said sections, said program information containing relationship of time elapsed from commencement of said program and said commercial information, along with playback order of priority of said commercial information and playback frequency.

19. A program record/playback method according to claim 18, further comprising:
determining whether to playback said commercial information based on said playback frequency of said commercial information contained in said program information, before reading out said data stream of said section selected by said viewer from said recording device;
selecting said commercial information that should be played back when said commercial information is played back based on said playback order of priority of said commercial information contained in said program information data;
reading out said data stream relating to said commercial information selected using the relationship between said commercial information and the time elapsed from commencement of said program; and
decoding said data stream relating to said commercial information read out and playing back a first image of said commercial information.

20. A program record/playback method comprising:
acquiring program data and program information data by broadcast waves or by telecommunications that shows a program containing sections and information about said sections in correlation with time elapsed from program commencement;
recording a first data stream of said program information data and a second data stream of said program data into a first recording portion of a recording device;
transmitting said first and second data streams of said program and information data to a portable terminal;
recording said first and second data streams transmitted into a second recording device of said portable terminal;
reading out said second data stream of said program information data recorded by said second recording device;
creating a program guide screen to introduce each section included in said program data based on said program information data read out;
displaying said program guide screen on said portable terminal and prompting a viewer to select a displayed section for viewing;
searching within said second recording device and reading out a data stream corresponding to the displayed section which said viewer selected, using the relationship between said sections contained in said program information data and the time elapsed from program commencement;
decoding said data stream read out and playing back an image of said displayed section; and
displaying said played back image on said portable terminal.

21. A recording/playback device comprising:
first receiving means for receiving a first data stream, said first data stream including program information data relating to sections of a program, said sections correlated to the time elapsed from program commencement;
second receiving means for receiving a second data stream including program data that contains said sections;
third receiving means for receiving a third data stream including program data that contains said sections;
coding means for encoding said third data stream;
recording means for storing said first, second, and third data streams;
graphic generating means for generating a guidance image that introduces said sections of said program based on said first data stream read out from said recording device;
control means for searching among said second data stream and said encoded third data stream of said program data to retrieve a data stream corresponding to any of said sections within said recording device, using the correlation between said program information data related to said sections and the time elapsed from program commencement;
decoding means for decoding at least a portion of one of said second data stream and said third encoded data stream read out using said control device and decoding and playing said one of said second and third encoded data stream to play back an image corresponding to said one of said second data stream and said third encoded data stream.

22. The program record/playback device according to claim 21, wherein said program information data further comprises:
image cropping means for cropping part of said image played back by said decoding means in accordance with playback range information showing a flag indicator for screen-enlargement playback correlated to time elapsed from program commencement; and
an image enlargement means for enlarging an image cropped by said image cropping means.

23. The program record/playback device according to claim 21, further comprising:
caption image creation means for reading character information included in said program information and playing the character information on a display device;

24. The program record/playback device according to claim 23, wherein said character information includes character data and a flag indicator for a character display related to said program in correlation to time elapsed from program commencement.

25. The program record/playback device according to claim 21, further comprising counting means for determining an order of commercial information to be played back between said second data stream and said third encoded data stream.
